(19) United States
(12) Patent Application Publication
(10) Pub. No.: US 2005/0150668 A1
(43) Pub. Date: Jul. 14, 2005

(54) Box scraper with scarifier

(76) Inventor: Jim Williamson, Willow Springs, MO (US)

Correspondence Address: LATHROP & GAGE LC, 1845 S. NATIONAL, P.O. BOX 4288, SPRINGFIELD, MO, 65101, US

(21) Appl. No.: 11/025,291

(22) Filed: Dec. 29, 2004

Related U.S. Application Data
(60) Provisional application No. 60/533,403, filed on Dec. 29, 2003.

(51) Int. Cl. A01B 5/00

(52) U.S. Cl. 172/297

(57) ABSTRACT

A box scraper and scarifier has a scraper box and a mid-blade mounted to the scraper box, intermediate a scarifier bar and a rear wall of the scraper box. The scarifier bar, which can be either fixed or retractable, is also mounted to the scraper box. The scarifier bar includes a plurality of chisels for scarifying the soil. Positioned near the rear wall of the scraper box may be a rear cutting blade. Three actuators mounted to the box scraper and scarifier may be used to achieve a desired cut angle for either the mid-blade or the rear blade. Further, a front drawbar assembly and a rear wheel assembly may stabilize the box scraper and scarifier during use. In one embodiment, a shackle assembly attaches the box scraper and scarifier to a skid loader or tractor.

### CROSS REFERENCE TO RELATED PROVISIONAL PATENT

This non-provisional application claims priority of the provisional application No. 60/533,403 filed on Dec. 29, 2003.

### BACKGROUND

Box scrapers have long been used for construction purposes to form, grade and level building sites, roadways, yards and the like. Generally, scrapers are simple boxes having a single cutting edge which removes dirt and rock as it is pulled across a cutting surface, e.g. soil. Removed dirt is accumulated in a box portion of the device. Early box scrapers were vertically-adjustable by mechanical levers, jacks and eventually hydraulics. Most scrapers utilize a single cutting edge and a single axis of elevation, adjustable by raising and lowering the rear-most section of the scraper at a single articulation point. The angle of cut is determined by the elevation of the rearward portion of the scraper. The higher the elevation, the greater the cut angle.

Generally, the performance of box scrapers is limited by the degree to which the scraper bounces vertically as it is dragged over the soil. Bouncing results in uneven removal of soil caused by the blade jumping over rocks and hard-packed soil. This unwanted and previously unavoidable movement of a box scraper degrades the performance of the scraper. Further, box scrapers rock back and forth between the hitch and the rear wheels, and from side to side as they are pulled across the cutting surface.

### SUMMARY

In one embodiment, the box scraper and scarifier includes: a scraper box; a scarifier bar having a plurality of chisels to selectively engage with a cutting surface; a primary blade movably and transversely mounted in the scraper box, intermediate the scarifier bar and a rear wall of the scraper box; a wheel assembly mounted to the scraper box; and, a draw bar assembly for towing the box scraper and scarifier during operation.

In other embodiments, the box scraper and scarifier may include: a strengthening bar mounted to the scraper box for minimizing flexure of the scraper box during use; a first articulation mechanism connected to the scarifier bar and the strengthening bar; and/or a second articulation mechanism connected to the wheel assembly and the rear wall of scraper box, the first and the second articulation mechanisms concertedly modifying the pitch of the scraper box during operation.

### BRIEF DESCRIPTION OF THE DRAWINGS

FIG. 1 is a perspective view of one box scraper and scarifier, according to an embodiment;

FIG. 2 is a side view of a blade mount of the box scraper and scarifier, according to an embodiment;

FIG. 3 is a side view of a blade mount of the box scraper and scarifier having elongated bolt holes, according to an embodiment;

FIG. 4 is a perspective view of one box scraper and scarifier having a hinged wheel assembly and stabilizers, according to an embodiment; and

FIG. 5 is a perspective view of one box scraper and scarifier having a shackle assembly, according to an embodiment.

### DETAILED DESCRIPTION

The present teaching is by way of example, not by limitation, and is not limited to use or application with one specific type of box scrapper and scarifier. Thus, although the instrumentalities described herein are for the convenience of explanation, shown and described with respect to exemplary embodiments, these principals may be equally applied in other types of box scrapper and scarifiers.

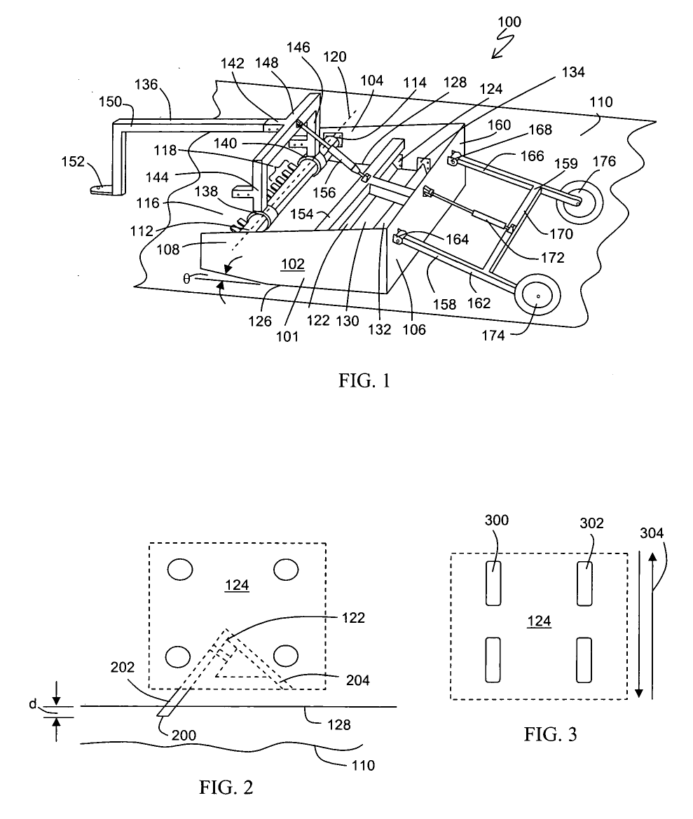

One box scraper and scarifier is shown in FIG. 1 and generally designated 100. The box scraper and scarifier 100 includes a scraper box 101 having a left wall 102 and a right wall 104, wherein the left 102 and right 104 walls are substantially opposite one another. Further, a rear wall 106 transversely interconnects the left 102 and right 104 walls.

Preferably, left wall 102 and right wall 104 taper, or narrow, in a direction away from rear wall 106. Moreover, left wall 102 and right wall 104 each have a forward section, of which section 108 of left wall 102 is exemplary. As shown in FIG. 1, forward section 108 tapers away from a cutting surface 110 (e.g. soil) at an angle “θ”. These forward sections, e.g. section 108, provide for clearance between the scraper box 101 and the cutting surface 110.

A scarifier bar 112 mounts transversely between left wall 102 and right wall 104, forward of rear wall 106. As shown in FIG. 1, scarifier bar 112 includes a mounting plate 114 which is bolted or otherwise mechanically attached to right wall 104. A similar mounting scheme is used to mount scarifier bar 112 to left wall 102. The scarifier bar 112 mounts in close proximity to a forward or leading edge 116 of the scraper box 101. The scarifier bar 112 includes a plurality of scarifier teeth or chisels, of which chisels 118 are exemplary. Chisels 118 are spaced an even distance apart along the length of scarifier bar 112, between left wall 102 and right wall 104. In one embodiment, scarifier bar 112 rotates about an axis of rotation 120, to selectively engage and disengage the plurality of chisels 118 with the cutting surface 110.

A mid-blade 122 mounts transversely between left wall 102 and right wall 104, and is positioned longitudinally between scarifier bar 112 and rear wall 106. As shown, mid-blade 122 includes a mounting plate 124 which is bolted or otherwise mechanically attached to right wall 104. A similar mounting scheme is used to mount mid-blade 122 to left wall 102. Cross-referencing FIGS. 1 and 2, the bottom edge 200 (FIG. 2) of mid-blade 122 is adjustable to a predetermined distance “d” below the bottom or lower edge 126 of left wall 102, and the bottom or lower edge 128 of right wall 104.

Referring now to FIGS. 2 and 3, it can be seen that mid-blade 122 includes a blade portion 202 and a support bar 204 which may be formed from angled iron and inverted into an upside down “V” orientation. The blade portion 202 attaches to the forward or leading edge of the inverted “V” bar 204. In one embodiment, mid-blade 122 vertically adjusts using a plurality of slotted bolt holes, of which bolt holes 300 and 302 in FIG. 3 are exemplary. In particular, mounting plate 124 moves vertically, in the direction of the arrows 304 in FIG. 3, to adjust the position of the bottom edge 200 of mid-blade 122 relative to cutting surface 110.

As mid-blade 122 engages cutting surface 110, mid-blade 122 removes a layer of soil, rocks and the like. The removed product is forcibly moved upward along blade portion 202 and over bar 204. This accumulation of soil, rocks and the like imparts a downward force on mid-blade 122 as the soil, etc., passes over mid-blade 122 and accumulates in compartment 130. This downward force stabilizes mid-blade 122 as it cuts, resulting in a smooth and consistent cut into the cutting surface 110.

As shown in FIG. 1, a rear blade 132 may removably mount between left wall 102 and right wall 104. Further, rear blade 132 may mount behind mid-blade 122, adjacent to rear wall 106. Similar to mid-blade 122, rear blade 132 includes a mounting plate 134 which is bolted or otherwise mechanically mounted to right wall 104. A similar mounting scheme is used to mount rear blade 132 to left wall 102. The rear blade 132 further removes soil and the like during operation. Also, rear blade 132 acts to compact soil into small holes and crevices created by mid-blade 122.

Still referring to FIG. 1, a front draw bar assembly 136 connects box scraper and scarifier 100 to a tractor or similar engine for towing during operation. The front draw bar assembly 136 comprises at least one attachment bracket, of which brackets 138 and 140 are exemplary. The attachment brackets 138, 140 fix the front draw bar assembly 136 to scarifier bar 112, or to other structural components of the scraper box 101 substantially near scarifier bar 112. When mounted to the scarifier bar 122, the brackets 138, 140 allow for the rotation of scarifier bar 122 as required for operations. The front draw bar assembly 136 also includes a support frame 142, which further includes a left vertical down support 144 and a right vertical down support 146. The down supports 144, 146 interface with the attachment brackets 138,140. A horizontal stabilizer 148 interconnects left support 144 and right support 146. Horizontal stabilizer 148 may be vertically aligned with, and substantially parallel to, scarifier bar 112.

A draw bar 150 removably attaches to horizontal stabilizer 148. The draw bar 150 extends generally forward of support frame 142. Draw bar 150 may extend forward of support frame 142 a sufficient distance to allow clearance of the towing vehicle during tight turn maneuvers. As shown in FIG. 1, draw bar 150 terminates in a hitch assembly 152.

The box scraper and scarifier 100 may also include a strengthening bar 154 mounted transversely between left wall 102 and right wall 104, adjacent to and above mid-blade 122. The strengthening bar 154 helps to minimize or eliminate flex or torque of the scraper box 101 during operation. The strengthening bar 154 is, for example, made of steel tubing and may rigidly mount to both walls 102, 104 of scraper box 101.

As further shown in FIG. 1, a hydraulic actuator 156 mounts to strengthening bar 154 and horizontal stabilizer 148 of support frame 142. Actuation of hydraulic actuator 156 operatively lowers or raises the scraper box 101, relative to cutting surface 110. This hydraulic actuator 156 constitutes the first articulation mechanism for the box scraper and scarifier 100. Raising and lowering strengthening bar 154 using hydraulic actuator 156 positions the mid-blade 122 to function as a cutting blade (in substantial contact with the cutting surface 110) or to function as a screed (in a position slightly removed from the cutting surface 110).

Continuing with FIG. 1, a rear wheel assembly 158 attaches to an outer surface 160 of rear wall 106. A frame 159 of the rear wheel assembly 158 includes a left wheel bar 162 pivotally attached to the outer surface 160 by an attachment bracket 164. The left wheel bar 162 is substantially parallel to, and spaced apart from, a right wheel bar 166. Similar to left wheel bar 162, right wheel bar 166 also pivotally attaches to outer surface 160 of rear wall 106 by a bracket 168. The left wheel bar 162 and right wheel bar 166 are supported and separated by a transverse wheel bar 170.

A hydraulic actuator 172 pivotally mounts to both the transverse wheel bar 170, and to outer surface 160 of rear wall 106. Actuation of hydraulic actuator 172, which may be in concert with the operation of hydraulic actuator 156, raises and lowers that portion of scraper box 101 closest to rear wall 106, and determines the dig angle or scraping angle of rear blade 132. This hydraulic actuator 172 constitutes the second articulation mechanism for box scraper and scarifier 100.

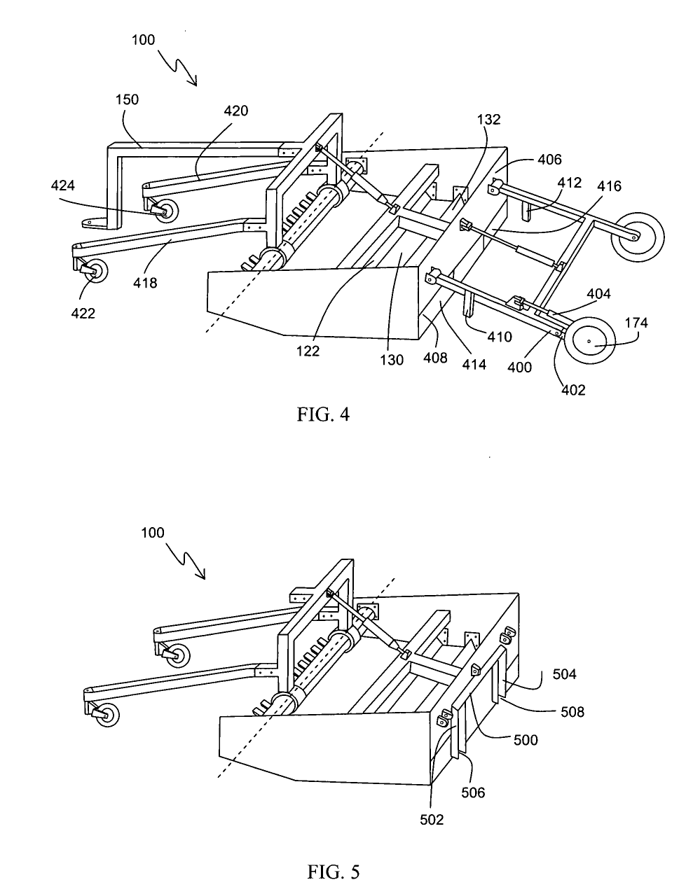

A left wheel 174 attaches to left wheel bar 162; and a right wheel 176 attaches to right wheel bar 166. In one embodiment, as shown in FIG. 4, left wheel bar 162 may include a hinged portion 400 adjacent to left wheel 174. The hinged portion 400 may include a hinged bar 402. Further, a hydraulic actuator 404 mounts to left wheel bar 162 and hinged bar 402. Actuation of hydraulic actuator 404 changes the overall slope angle of the scraper box 101 and, hence, the cut angles of blades 122, 132. This embodiment allows box scraper and scarifier 100 to be used for contouring the ground and cutting sloped surfaces. It is to be understood that hydraulic actuator 404 and hinged bar 402 can be positioned on either the left 162 or the right 166 wheel bar. This hydraulic actuator 404 constitutes the third articulation mechanism for box scraper and scarifier 100.

In yet another embodiment, as further shown in FIG. 4, rear wall 106 may include a rigid and reinforced upper section 406, and a lower section 408 hinged to the upper section 406. The lower section 408 opens or swings generally in the direction of rear wheel assembly 158, and will open until contacting at least one stop, of which stops 410 and 412 are exemplary. During normal scraping operations, lower section 408 may be fastened so as to prevent the swinging or opening of lower section 408. More specifically, lower section 408 may be fastened at each of the left 102 and right 104 walls. In one embodiment, lower section 408 includes a left 414 and a right 416 hinged section. Either one or both hinged sections 414, 416 of lower section 408 can be released and allowed to swing generally toward a stop 410, 412. This embodiment allows work material such as dirt to pass through the compartment 130 of box scraper and scarifier 100. If only one end 414, 416 of lower section 408 is released, the work material will be directionally “graded” similar to the blade of a road grader.

Still another embodiment includes a left stabilizer 418 and right stabilizer 420 positioned on either side of draw bar 150. The stabilizers 418, 420 removably attach to left vertical down support 144 and right vertical down support 146 respectively. A left wheel assembly 422 attaches to left stabilizer 418, and a right wheel assembly 424 attaches to right stabilizer 420. The stabilizers 418, 420 generally stabilize the box scraper and scarifier 100, and further limit bounce of box scraper and scarifier 100 during operation.

Referring now to FIG. 5, in one embodiment a shackle system 500 mounts to rear wall 106. During operation of box scraper and scarifier 100, shackle system 500 attaches to a skid loader or skid tractor, either of which is used to move the box scraper and scarifier 100 forward. The rear wheel assembly 158 and front draw bar assembly 136 are both removed from box scraper and scarifier 100 when shackle system 500 is employed. As shown, shackle system 500 includes a pair of spaced apart vertical support members, 502 and 504, which receive and hold securely the universal mount of a skid loader. Further, rear wall 106 may include openings 506 and 508, in proximity to the bottom of each vertical support member, 502 and 504 respectively. In this configuration, openings 506, 508 receive the skid loader forks prior to operation. The forks of the skid loader are positioned within openings 506, 508 in rear wall 106, and box scraper and scarifier 100 is used as a front mount box scraper 100.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

1. A box scraper and scarifier comprising:
a scraper box having a first wall, a second wall, and a third wall interconnecting the first wall and the second wall;
a scarifier bar having a plurality of chisels, wherein the chisels selectively engage with a cutting surface;
a primary blade movably and transversely mounted between the first wall and the second wall of the scraper box, intermediate the scarifier bar and the third wall of the scraper box;
a wheel assembly mounted to an outer surface of the third wall; and
a draw bar assembly for towing the box scraper and scarifier during operation.

2. The box scraper and scarifier of claim 1, further comprising:
a first stabilizer; and
a second stabilizer, wherein the first and the second stabilizers mount to the draw bar assembly.

3. The box scraper and scarifier of claim 1, further comprising a secondary blade positioned adjacent to the third wall of the scraper box.

4. The box scraper and scarifier of claim 1, wherein the wheel assembly further comprises:
a hinged bar connected to a frame of the wheel assembly;
a first actuator mounted to the wheel assembly and third wall, for selectively adjusting the pitch of the scraper box; and
a second actuator coupled to the hinged bar and frame of the wheel assembly, for selectively adjusting the pitch of the scraper box.

5. The box scraper and scarifier of claim 1, wherein the third wall further comprises:
a first section; and
a second section, wherein the first section and the second section each extend between the first and the second wall of the scrapper box, and further wherein the second section is hinged to the first section and is movable in a direction substantially toward the wheel assembly.

6. The box scraper and scarifier of claim 1, further comprising a shackle assembly removably mounted to the outer surface of the third wall.

7. The box scraper and scarifier of claim 1, further comprising a strengthening bar mounted transversely between the first wall and second wall of the scraper box.

8. The box scrapper and scarifier of claim 7, wherein the draw bar assembly further comprises:
a support frame mounted to the scarifier bar; and
a hydraulic actuator coupled to the support frame and the strengthening bar for selectively adjusting the pitch of the scraper box.

9. A box scraper and scarifier comprising:
a scraper box;
a strengthening bar mounted with the scraper box for minimizing flexure of the scraper box during operation;
a scarifier bar having a plurality of chisels, wherein the chisels selectively engage with a cutting surface;
a primary blade movably mounted to the scraper box, intermediate the scarifier bar and a transverse wall of the scraper box;
a wheel assembly mounted to an outer surface of the transverse wall;
a draw bar assembly attached to the scarifier bar to tow the box scraper and scarifier during operation;
a first articulation mechanism connected to the scarifier bar and the strengthening bar; and
a second articulation mechanism connected to the wheel assembly and the transverse wall of scraper box, wherein the first and the second articulation mechanisms concertedly modify the pitch of the scraper box to set a primary blade cutting angle.

10. The box scraper and scarifier of claim 9, further comprising:
a first stabilizer; and
a second stabilizer, wherein the first and the second stabilizers mount to the draw bar assembly.

11. The box scraper and scarifier of claim 9, further comprising a secondary blade positioned adjacent to the transverse wall of the scraper box.

12. The box scraper and scarifier of claim 9 wherein the transverse wall further comprises:
a first section; and
a second section, wherein the second section is hinged to the first section and is movable in a direction substantially toward the wheel assembly.

13. The box scraper and scarifier of claim 9, further comprising a shackle assembly removably mounted to the outer surface of the transverse wall.

14. The box scraper and scarifier of claim 9, wherein the first articulation mechanism is a hydraulic actuator.

15. The box scraper and scarifier of claim 9, wherein the second articulation mechanism is a hydraulic actuator.

16. The box scraper and scarifier of claim 9 wherein the wheel assembly further comprises:
a hinged bar connected to a frame of the wheel assembly; and
a third articulation mechanism coupled to the hinged bar and frame of the wheel assembly, for selectively adjusting the pitch of the scraper box.

17. A method of grading soil, comprising:
adjusting position of a first blade, of a box scraper and scarifier, to a predetermined height above a surface of the soil;
adjusting position of a second blade, of the box scraper and scarifier, to a predetermined height above the surface;
selectively adjusting pitch of the box scraper and scarifier to modify cutting angle and depth of cuts of the first and second blades;
scarifying the surface; and
cutting and scraping the soil.

18. The method of claim 17, wherein the step of adjusting pitch comprises:
selectively employing a first hydraulic actuator; and
selectively employing a second hydraulic actuator, in concert with the first hydraulic actuator, to adjust the pitch of the scraper box.

19. The method of claim 17, further comprising stabilizing, during operation, the box scraper and scarifier.

20. The method of claim 17, further comprising:
removably attaching a shackle assembly to the box scraper and scarifier;
mounting the box scraper and scarifier to a skid loader or skid tractor; and
moving the box scraper and scarifier in a forward direction to grade the soil.
